(19) United States
(12) Patent Application Publication
(10) Pub. No.: US 2006/0002381 A1
(43) Pub. Date: Jan. 5, 2006

(54) Signaling for Internet end stations

(76) Inventor: Michael Socaciu, Westford, MA (US)

Correspondence Address: KENNETH F. KOZIK, ESQ.;HOLLAND & KNIGHT LLP, 10 ST. JAMES AVENUE, BOSTON, MA, 02116, US

(21) Appl. No.: 11/223,593

(22) Filed: Sep. 9, 2005

Related U.S. Application Data
(63) Continuation-in-part of application No. 08/987,411, filed on Dec. 9, 1997, now Pat. No. 6,542,498.

(51) Int. Cl. H04L 12/66

(52) U.S. Cl. 370/352

(57) ABSTRACT

Methods and apparatus, including computer program products, for signaling for Internet end stations. A signaling method includes a method of signaling including establishing a Packet Switched Telephone Network (PSTN) connection between a first end station having a first PSTN address and a first Internet address, and a second end station having a second PSTN address and a second Internet address, determining whether the end stations support Internet signaling, in response to determining, directly exchanging Internet addresses between the first Internet end station and the second Internet end station over the PSTN connection, disconnecting the PSTN connection, and establishing an end-to-end Internet connection between the first end station and the second end station.

### CROSS REFERENCE TO RELATED APPLICATIONS

This application is a continuation-in-part of U.S. Pat. No. 6,542,498, filed on Dec. 9, 1997, and issued on Apr. 1, 2003, the entire contents of which are incorporated herein by reference.

### BACKGROUND

The present invention relates to data processing by digital computer, and more particularly to signaling for Internet end stations.

A traditional telephone accesses its party through a Plain Old Telephone (POT) Network. The functions of a traditional phone typically involve tone recognition (i.e., dial, busy, ring), dual tone multi frequency (DTMF) tones generation, and voice analog signal transfer. The traditional telephone gets a line (i.e., hook off), dials, waits to connect to another party, and then establishes a full duplex voice connection. Through dialing, POT network protocols allow connection to any subscriber, at any desired time.

Traditional telephone access is accomplished at any desire time because each telephone has a unique, fixed address, and by hook-off it connects to the transport network. This unique fixed address is generally referred to as a telephone number. Establishing a connection using the Internet in place of the POT network access presents a unique problem. One cannot use the Internet to make an end-to-end connection unless each end station is connected (or attached) to the Internet prior to making the Internet connection. Furthermore, the same party may receive each time it attaches (or connects) to the Internet a different Internet Protocol (IP) address. This is generally referred to as dynamic addressing. Therefore, it is difficult to connect two parties or end stations with a telephone using the Internet because of this dynamic addressing. This dynamic Internet network addressing differs from the fixed addressing associated with the POTS network.

### SUMMARY

The present invention provides methods and apparatus, including computer program products, for signaling for Internet end stations.

In general, in one aspect, the invention features a method of signaling including establishing a Packet Switched Telephone Network (PSTN) connection between a first end station having a first PSTN address and a first Internet address, and a second end station having a second PSTN address and a second Internet address, determining whether the end stations support Internet signaling, in response to determining, directly exchanging Internet addresses between the first Internet end station and the second Internet end station over the PSTN connection, disconnecting the PSTN connection, and establishing an end-to-end Internet connection between the first end station and the second end station.

In embodiments, the method can include exchanging Internet traffic over the end-to-end Internet connection, and terminating the end-to-end Internet connection.

The method can include, in response to determining, resuming communication over the PSTN, and terminating the end-to-end PSTN connection.

The invention can be implemented to realize one or more of the following advantages.

End stations use expensive circuit switched communication for short periods of times for signaling, while traffic is exchanged for long periods of time over the less expensive Internet.

End stations can alert each other. End stations attached only to the Internet need support in the Internet to call each other. For example, Voice over Internet (VoIP) stations need service support in order to establish connections and communicate. The method uses the world known telephone directory numbers to establish connections and does not depend on specialized deployments in the Internet. The method enables end users and service providers to rapidly implement VoIP networks with minimal cost. The method simplifies the operation of technologies such as Session Initiation Protocol (SIP) by providing SIP alerting directly between end stations.

Internet appliances, such as voice, video or text messengers, generally establish communications between end stations that register with servers and depend on their party's presence on the Internet. The method enables a way to alert parties as traditional telephones do, at any given time, regardless of their party's operational state.

Multiple simultaneous conversations can occur on a single subscribed line.

In case of failure of the Internet or loss of power, the method provides an immediate alternative communication over the public switched telephone network (PSTN), i.e., 911 is always enabled.

One implementation of the invention provides all of the above advantages.

Other features and advantages of the invention are apparent from the following description, and from the claims.

### BRIEF DESCRIPTION OF THE DRAWINGS

FIG. 1 is a block diagram of a network.

FIG. 2 is a flow diagram.

FIG. 3 is a block diagram.

FIG. 4 is a block diagram.

FIG. 5 is a block diagram.

FIG. 6 is a block diagram.

Like reference numbers and designations in the various drawings indicate like

### DETAILED DESCRIPTION

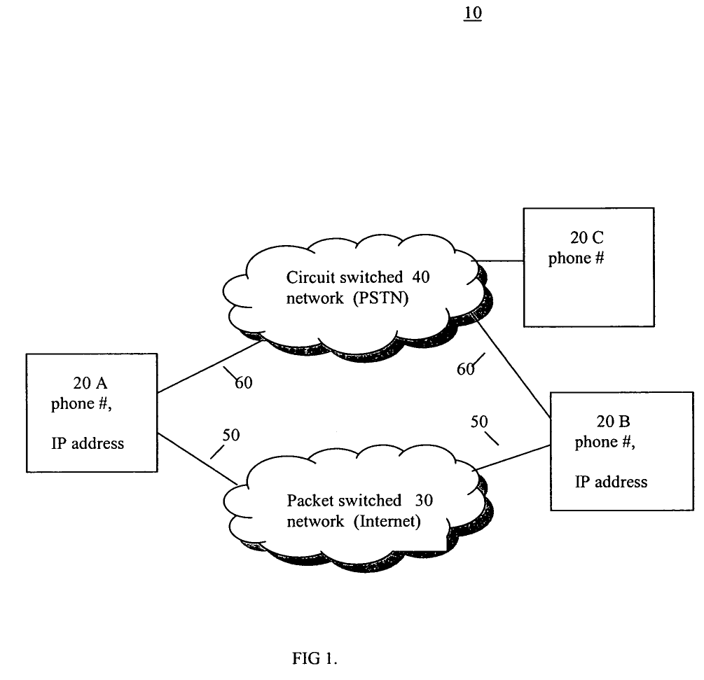

As shown in FIG. 1 an exemplary communication system 10 includes end stations 20A, 20B and 20C. System 10 enables end station 20A to establish a connection over an Internet 30 to peer end station 20B by signaling over a public switched telephone network (PSTN) 40. End stations 20A and 20B are connected to the PSTN 40 and the Internet 30. At the time of subscribing to the PSTN service, the end stations 20A, 20B, 20C receive a PSTN address, i.e. a telephone number. The end stations 20A, 20B are connected to the Internet 30 on an “always on” connection 50. Using connection 50, the end stations 20A and 20B can receive either fixed Internet Protocol (IP) addresses at the time of subscribing to an Internet service or receive dynamic IP addresses, e.g., during boot up time. The end stations 20A, 20B, when operational, include both a phone number and an IP address. The “always on” Internet connection 50 can be, for example, a Digital Subscriber Line (DSL) connection, a cable network connection, e.g., cable modem, or a Wireless Wide Area Network (WWAN) connection. The PSTN connection 60 can be, for example, an analog plain old telephone (POT) connection or a digital Integrated Services Digital Network (ISDN) connection.

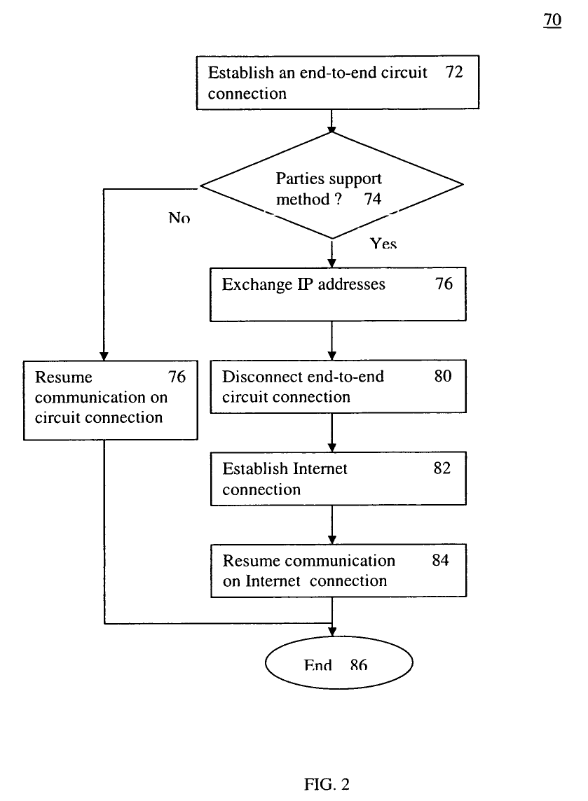

As shown in FIG. 2, a process 70 can run on system 10 and enables an establishment of either an Internet or a PSTN connection between peer end stations, such as end stations 20A, 20B, 20C. One of the end stations, for example end station 20A establishes (72) an end-to-end circuit switched connection to end station 20B. In one particular example, this is established (72) an analog connection 60 as the end station 20A dials the phone number of end station 20B. When end station 20B answers the call, end station 20B plays a short tone recognizable by the calling end station 20A, indicating a support signal (74). Upon receipt of the support signal, the end station 20A transmits (78) its Internet Protocol (IP) address over the end-to-end PSTN connection to peer end station 20B. In one particular example, the end station 20B transmits (78) its IP address to the calling end station 20A. In other examples, the end station 20B may not transmit its IP address. After the end stations 20A, 20B exchange (78) IP addresses, the end stations 20A, 20B disconnect (80) from the PSTN connection 60. One of the peer end stations, for example, end station 20B, establishes (82) an Internet connection to the other peer end station, based on the IP address of the peer end station. Either a Transmission Control Protocol/Internet Protocol (TCP/IP) or a User Datagram Protocol (UDP) connection can be established. The peer end stations 20A, 20B can now communicate (84) over the Internet 30, exchanging traffic that can carry voice, images, video or text.

When the PSTN connection 60 is a digital ISDN connection, the peer end stations 20A, 20B can use ISDN messages to indicate signaling support (74). For example, SETUP messages, which include the destination phone number of the called end station, can also include an information element that specifies that the caller end station supports the method. A SETUP ACKNOWLEDGE message may specify that the called end stations is capable of signaling support (74). FACILITY or SETUP messages can be used to exchange (78) IP addresses between peer end stations. Regardless of the type of the PSTN connection 60, when the caller end station 20A reaches an end station with no connection 50 to the Internet 30, for example, end station 20C, the end station 20A determines (74) that the station 20C does not support signaling, as the end station 20C does not transmit a short tone recognizable by the caller and station 20A. In this event, the end station 20A does not attempt to transmit its IP address, but rather, the end stations 20A and 20C communicate (76) over the PSTN circuit. Process 70 now ends (86).

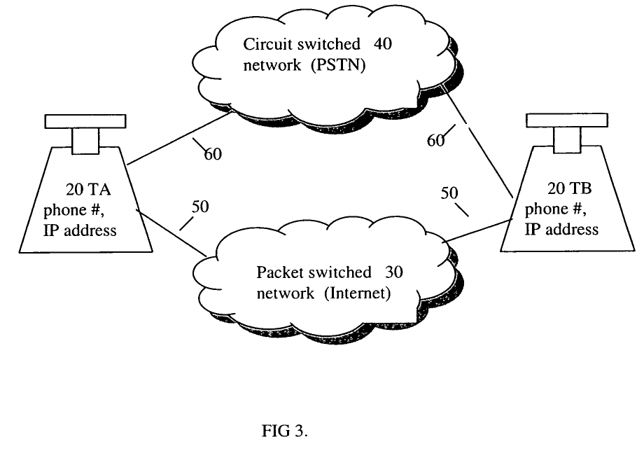

As shown in FIG. 3, two exemplary telephones 20TA and 20TB are adapted to include elements of the end stations 20A, 20B (fully described below) and establish communication according to process 70. For example, a user at the adapted telephone 20TA dials a phone number of adapted telephone 20TB and establishes (72) a PSTN connection. When a user of adapted telephone 20TB answers, the adapted telephone 20TB transmits a short recognizable tone that determines (74) whether the adapted telephone 20TA can establish signaling with end station 20TB. Is so, the adapted telephones 20TA and 20TB exchange (78) their IP addresses over the end-to-end PSTN connection, disconnect (80) the end-to-end PSTN connection, establish (82) an Internet connection and communicate (84) over the Internet.

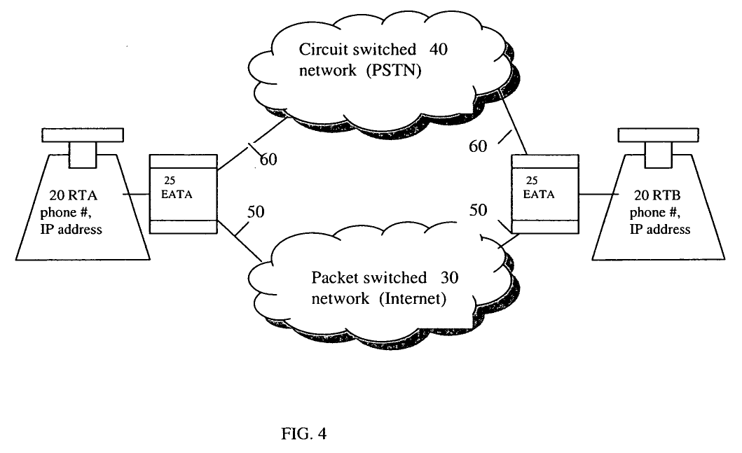

As shown in FIG. 4, two exemplary telephones 20RTA, 20RTB include extended analog telephone adapters (EATA) to establish communication signaling over PSTN 40. A voice communication follows over Internet 30. Analog telephone adapters are devices that enable telephones to operate as Voice over Internet Protocol (VoIP) telephones. EATAs that operate according to the method include a regular telephone interface that supports POT signaling. When dialing from the regular telephones 20 RTA, 20 RTB, the EATA regular telephone interface is used to dial over the PSTN. EATAs include hardware of end stations 20A, 20B and support operation according to process 70. The EATAs are capable of detecting DTMF tones and recognizing that the peer parties support signaling. EATAs are directly connected to the Internet 30 from where the EATAs are assigned IP addresses. When both parties are connected by EATAs, the EATAs exchange their IP addresses and establish an Internet connection. On the established Internet connection, EATAs exchange digitized and packetized voice signal originated by the regular phones 20 RTA, 20 RTB.

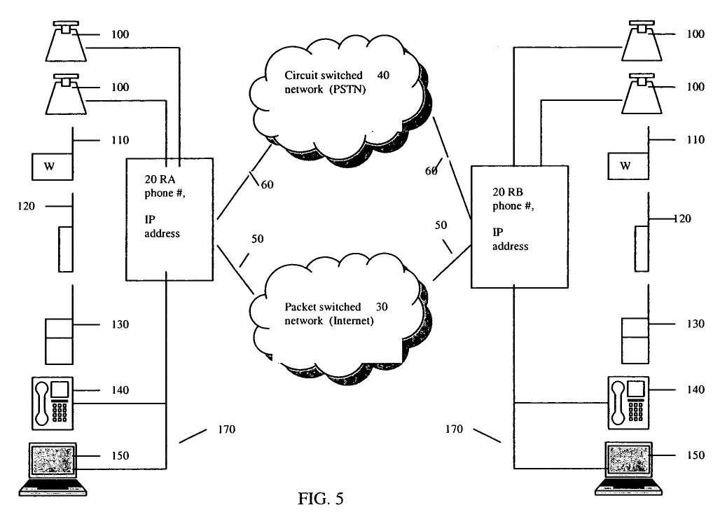

As shown in FIG. 5, end stations 20RA and 20RB establish Internet connections between different devices by signaling over the PSTN. The end stations 20RA and 20RB are connected to PSTN 40 and Internet 30 and include a phone number and an IP address. Connected to end stations 20RA, 20RB are devices, such as, for example, regular telephones 100 and cordless telephones 110. To communicate with the regular telephones phones 100 and the cordless telephones phones 110, the end stations 20RA and 20RB, include interfaces such as those used in private branch exchanges (PBX). Examples include, but are not limited to, interfaces used in the General Electric 25831GE3 5.8 GHZ Digital Cordless Phone System or Panasonic KX-T7885 Multi-Line Phone System.

VoIP phones 140 and software VoIP phone applications running in personal computers (PCs) 150 are connected to the end stations 20RA, 20RB over Local Area Networks (LANs) 170, which support local IP traffic.

The end stations 20RA, 20RB can include a pico base station interface, such as, for example, the 2401 Ericsson indoor base station or Kevab's pico base station. When cellular phones 120 are proximate to the end stations 20RA, 20RB, the end stations 20RA, 20RB act like pico base stations. In general, a pico base station provides wireless connectivity to an interior of a building. When end stations 20RA, 20RB are deployed in home/small offices (SOHOs), a smaller version of a pico base station suffices, as only a limited number of cellular phones are served by the pico base station at any given time. As with the cellular phones, dual wireless devices that include both voice cellular network and wireless Internet capabilities can be served by a pico base station interface. The end stations 20RA, 20RB can include a wireless IEEE 802.11 LAN interface.

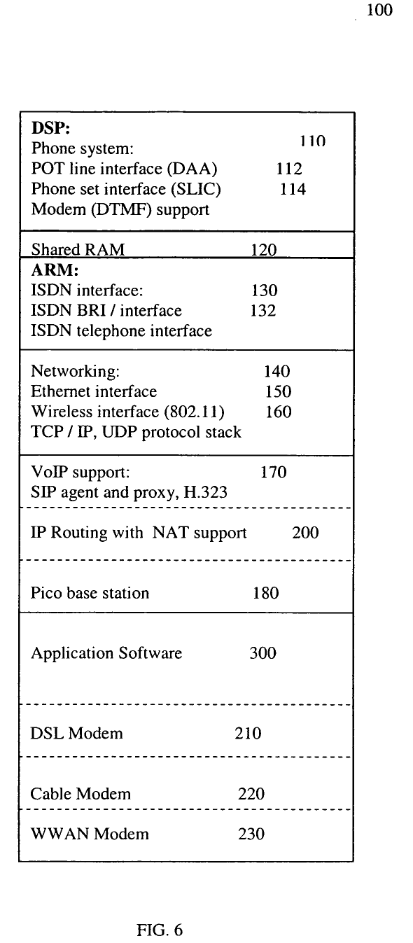

As shown in FIG. 6, an exemplary end station 100 includes components implemented on a digital signal processor (DSP) system, such as on a Texas Instruments TMS320C54CST, and on an advanced reduced instruction set computer (RISC) system, such as Intel's SA1110 StrongARM®. In other example, any DSP or ARM processor may be used. The two processors communicate through shared memory random access memory (RAM) 120.

The DSP system runs phone system 110 telephony support, which includes dual tone multiple frequencies (DTMF) detection and translation. The DSP system has a data access arrangement (DAA) interface 112 to the POT PSTN. The DSP system interfaces to regular phones 100 using analog subscriber line interface (SLIC) 114.

The ARM system runs ISDN support to interface to ISDN phones and a basic rate ISDN interface (BRI) 132 to the ISDN PSTN. On the BRI interfae 132, the end stations use the Signaling D channel to exchange ISDN signaling messages with the appropriate end station.

The ARM system runs networking support 140 that includes a wire-line Ethernet physical interface 150 capable of interfacing to a set of VoIP phones and PCs. The networking support includes a physical wireless Wi-Fi 802.11 interface 160. On top of the physical interfaces an Internet protocol IP stack runs that includes TCP and UDP support. Over the physical interfaces, in one example, the end stations are connected to wire-line or a wireless router 200. In other examples, the router 200 is integrated in the end station. The router 200 has network address translation (NAT) capabilities.

The ARM system has VoIP support 170 that includes session initiation protocol (SIP) and H.323 protocol stacks. The SIP support includes both agent and proxy support. SIP agents and proxies communicate with peer SIP agents and/or proxies located in peer end stations.

The ARM system includes pico base station support 180. The pico base stations are used to increase cellular network coverage in interior environments. The end stations 20RA, 20RB pico base station support is very low power, targeted to support home and small business cellular phones and dual wireless devices. The role of the pico base station support 180 is to communicate with the cell phones 120 and dual devices 130 that are in the proximity of the end stations 20RA, 20RB, capture the dial signals from the cell phones 120 and dual devices 130 and maintain wireless voice communication with the cell phones 120 and dual devices 130.

In some examples, the end stations 20RA, 20RB include a router 200 with Network Address Translation (NAT) capabilities and one or more of a DSL modem 210, Cable modem 220 or WWAN modem 230. The DSL 210, Cable 220 and WWAN 230 modems are used to connect to the Internet 30 under an “always on” subscription. In other examples, the router 200, the DSL modem 210, the Cable modem 220 and the WWAN modem 230 are third party devices. In this case, the end stations 20RA, 20RB are connected to the router 20 using either the Ethernet interface 150 or the Wi-Fi interface 160 and the router 200 is connected to modems using Ethernet connections.

The end stations 20RA, 20RB include application software 300, which controls and coordinates the other components to operate according to process 70. When any of the regular phones 100, cordless phones 110, cell phones 120, dual phone devices 130, VoIP phones 140 or PC 150 dials a PSTN party phone number, through the corresponding interfaces, the application software 300 captures the PSTN party phone number. The application software 300 calls the party using either the POT interface 112 or the BRI ISDN interface 132, according to the PSTN party phone number. The application software 300 turns on DTMF detection and monitors the called end station. If the called end station transmits a short recognizable DTMF signal, the application software 300 in the calling end station determines whether the called end station supports signaling. . In the particular case of the regular phones 110, the end stations 20RA, 20RB, may alternatively relay the dialing DTMF tones from the regular phones 110 to the DAA interface 112 directly. The phones 110 do this way the dialing. The application software 300 retrieves the IP address of the end station from the networking support 140 and transmits the IP address to the called end station over the POT interface 112 or the BRI ISDN interface 132, using respectively the DSP DTMF support or the ISDN messaging. In some examples, the application software 300 in the called end station transmits the IP address of the called end station to the calling end station. After exchanging IP addresses, the application software 300 in the peer end stations disconnects the PSTN connection. The application software 300, for example, in the called end station, establishes an Internet connection to the peer end station. On the established Internet connection, one exchanges packetized voice traffic commonly used in VoIP. The voice traffic from end devices such as the regular phones 110, cordless phones 110, cell phones 120, dual phone devices 130 is digitized and packetized by the VoIP component 140. The voice traffic from end devices such as VoIP phones 140 or PC 150 is in form of digitized and packetized voice and the end stations 20RA, 20RB route the traffic the networking (IP) support and the router 200 support. To direct the call to a particular end device, such as the regular phones 110, cordless phones 110, cell phones 120, dual phone devices 130, VoIP phones 140 or PC 150, the end stations 20RA, 20RB, can use, for example, the SIP protocol. A SIP proxy is capable of establishing connections on behalf of end devices, using NAT and appropriate router port forwarding techniques. After disconnecting the PSTN connection during establishing the Internet connection between any peer end devices connected to peer end stations 20RA, 20RB, the end stations 20RA, 20RB can start to establish subsequent Internet connections between end devices connected to the end stations 20RA, 20RB. The PSTN connections are used intermittently for short periods of time to establish Internet connections between end devices connected to the end stations 20RA, 20RB.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method of signaling comprising:
establishing a Packet Switched Telephone Network (PSTN) connection between a first end station having a first PSTN address and a first Internet address, and a second end station having a second PSTN address and a second Internet address;
determining whether the end stations support Internet signaling;
in response to determining, directly exchanging Internet addresses between the first Internet end station and the second Internet end station over the PSTN connection;
disconnecting the PSTN connection; and
establishing an end-to-end Internet connection between the first end station and the second end station.

2. The method of claim 1 further comprising:
exchanging Internet traffic over the end-to-end Internet connection; and
terminating the end-to-end Internet connection.

3. The method of claim 1 further comprising:
in response to determining, resuming communication over the PSTN; and
terminating the end-to-end PSTN connection.
